(19) United States
(12) Patent Application Publication
(10) Pub. No.: US 2005/0229155 A1
(43) Pub. Date: Oct. 13, 2005

(54) Generic knowledge agents

(76) Inventor: Paul Guignard, Batemans Bay (AU)

Correspondence Address: DLA PIPER RUDNICK GRAY CARY US, LLP, 2000 University Avenue, E. Palo Alto, CA, 94303-2248, US

(21) Appl. No.: 10/450,975

(22) PCT Filed: Dec. 19, 2001
(86) PCT No.: PCT/AU01/01631

§ 371 Date: Feb. 23, 2004

(30) Foreign Application Priority Data
Dec. 19, 2000 (AU) PR2152

(51) Int. Cl. G06F 9/44

(52) U.S. Cl. 717/110

(57) ABSTRACT

This invention concerns a generic knowledge software agent, or kuark, existing within a knowledge environment. The kuark comprises: a defined domain of discourse within the environment which determines a source context of information detectable by the kuark, and a destination context of information identifiable by the kuark. The kuark has a defined source region, or pattern, within the and problems source context and a mapping between that source region and a defined destination region, or pattern, within the destination context. The kuark detects all environmental parameters compatible with the source region and source context so that when the source region is satisfied the mapping fires to determine the destination region in the destination context and makes it available to the environment where it can be observed by a user. It also concerns systems or kitems, made up of kuarks and a process for constructing them. It also concerns mult-kitem systems and searching processes for those systems. Finally it also concerns software agents and a knowledge management system comprising kitems.

### TECHNICAL FIELD

This invention concerns generic knowledge software agents, or kuarks, and their use as the building blocks for agent based applications. It also concerns systems or kitems, made up of kuarks and a process for constructing them. It also concerns mult-kitem systems and searching processes for those systems. Finally it also cocerns software agents and a knowledge management system comprising kitems.

### BACKGROUND ART

The model for the agents uses the inventions described in International Patent Application No. PCT/AU99/00501 entitled ‘Generic Knowledge Management System’ (GKMS), and Australian provisional patent application no PR0852 entitled ‘Networked Knowledge Management And Learning’ (NKML) both of which are incorporated herein by reference. A summary of these knowledge models will now be given with reference to FIGS. 1 to 4.

A computerised generic knowledge management system, comprises:

a multi-dimensional global space within computer memory defined by attributes, where each attribute defines a feature of the external world or the internal state of the system, or actions that can be taken to modify them, and each attribute is a dimension of the global space;

a source space, within the global space, made up of selected ones of the attributes to define a context in which to state problems;

a destination space, within the global space, made of selected ones of the attributes to define a context in which to provide answers to problems stated in the source space;

mappings between defined parts of the source space which each represent one or more stated problems, to defined parts of the destination space which each represent one or more answers expressing and embodying knowledge supplied by experts appropriate to the respective problems stated in the part of the source space.

Knowledge is mapped as regions (or patterns) in a source (or problem) space that are linked to regions (or patterns) in a destination (or solution) space, as illustrated in FIG. 1. The interactions for defining the problem and solution spaces, and for defining the mappings, and the interactions for accessing the knowledge take place in a network of client-servers, as illustrated in FIG. 2. FIGS. 3 and 4 show the decision-making process and the knowledge capture process, and how knowledge can be improved on an on-going basis. FIG. 4 is an extension of FIG. 3 in which the consequences of the decisions taken by a GKMS are evaluated and used to qualify the knowledge in the GKMS. Once again it involves signal exchanges between servers and clients.

The accepted architecture for agents is summarized in FIGS. 5 and 6. FIG. 5 illustrates the BDI model, that is agents have Beliefs, Desires and Intentions. FIG. 5 shows that in each part of the BDI model, agents need knowledge to be able to operate. They must have belief which is knowledge about what their role in existence is. Their desires or goals represent knowledge about what they are capable of and their intentions represent the knowledge about implementing the goals. Similarly, each of the DBI boxes in FIG. 5 is made of components, each representing a kind of knowledge in its category.

All these different types of knowledge can be easily and conveniently represented using the GKMS model for knowledge. In addition, the use of that knowledge can be supported by the knowledge processing described in the GKMS patent.

This means that the advantages of the GKMS model for knowledge representation and processing can become available to agents. It is also important to note that the use of the GKMS knowledge model for representation and processing is not restricted to the categories of knowledge shown in FIG. 5, but to any knowledge that may be useful in agents.

FIG. 6 shows how an agent situated in an environment interacts with this environment. Th interaction is very similar to FIGS. 3 and 4 which show how interaction with the environment and learning can take place in the GKMS model. Therefore the GKMS model is also suitable for dealing with agents interacting with their environments and learning in the process.

### SUMMARY OF THE INVENTION

The invention is a generic knowledge software agent, or kuark, existing within a knowledge environment, and comprising:

a defined domain of discourse within the environment which determines a source context of information detectable by the kuark and a destination context of information identifiable by the kuark;

the kuark having a defined source region, or pattern, within the source context and a mapping between that source region and a defined destination region, or pattern, within the destination context; and

the kuark detects all environmental parameters compatible with the source region and source context so that when the source region is satisfied the mapping fires to determine the destination region in the destination context and makes it available to the environment where it can be observed by a user.

So the kuark makes predetermined information automatically available to a user when input criteria are met. The kuark is only able to detect parameters that fall within its defined source context and when the environment satisfies the source region the mapping is triggered. The source region may be identicle to the source context, or it may be a subset within it.

A kuark may comprise many other elements, such as:
a univeral id;
a title;
an explanation, which may be multimedia;
a time and date created;
an author;
a time and date when last modified;
a person who last modified agent;
a version number;
a status to an enquiry, such as available, candidate, rejected, definite;
a description of the source context at time of last firing;
a description of destination context after last firing; and, links to other kuarks.
The links implement relationships to other kuarks. The are four links:
The hierarchical parent's universal id, and more than one parents could be allowed;
The id of the previous version kuark;
The ids of the kuarks that are part of this kuark;
The ids of the kuarks this kuark belongs to or is associated with. This last link may be implemented as separate kuark(s) designed to contain the IDs of the kuarks the kuark in question relates (or belongs) to.

The kuark may also operate to do the following:
Create a daughter/parent kuark;
Adopt an existing kuark as daughter or parent;
Display an internal state (contexts, regions, mapping); and
Make a copy each time it fires.

It is possible to implement these methods outside the current kuark, in a separate class or subroutine for example.

A first special kuark, known as a ‘relevance kuark’, determines the relevance of the environment, and depending on the the state of the environment with respect to the source context and source region, the kuark fires a relevance mapping that determines (calculates) the relevance of the environment. The relevance can be expressed as a probability.

The destination context may be made of the different relevance values that the environment can take with respect to the source context and region. For example, the values could be ‘definitely relevant’, ‘possibly relevant’, ‘relevant’, ‘likely not relevant’, ‘not relevant’.

Another special kuark is known as a ‘procedure kuark’, and contains as a mapping a (usually small) program or procedure that takes as input some elements of the source context and produces, as output, a pattern that fits within the destination context. This kuark executes its mapping when the environment is compatible with the source context and the region. That is, the input to the procedure is the source region in the source context. The destination context describes the range of outputs the procedure can produce when run, and the destination region or pattern is the actual result of the execution of the mapping, using an instance of the environment.

Kuarks may be implemented as classes and objects using an object oriented language such as Java. A kuark is a class in OOP and some of its properties are static, final, etc. A kuark that is given values for its source and destination contexts and regions are objects or instances of the corresponding kuark class.

A system made of several kuarks is still a kuark with all the allowed properties and methods, but is known as a ‘kitem’. In a kitem all the component kuark and kitems may keep their identities. The new kitem may have its own properties and methods in addition to those of its component kitems. The new kitem may have its own title and explanation, and may also have its own source and destination contexts and regions, and its own mapping.

A kitem may be constructed form kuarks and kitems by the following process:
concatenating the source contexts;
concatenating the destination contexts;
concatenating the source regions;
concatenating the destination regions;
concatenating the mappings;
concatenating the explanations.

Here concatenates means ‘take the union’ of the entities in question; for mappings, it is the juxtaposition of the individual mappings. The kitem construction process may also build the list of kuarks or kitems that are part of the new kitem.

Typically, when a kitem is built, all its components (kuarks or kitems) keep their individual contexts. Alternatively the kitem construction process may be set so that all components get the same source and destination contexts, that is the concatenation of the individual contexts of the kitem components.

A kuark or kitem can be represented as an object using an object oriented language such as Java. A kitem can be expressed as an object containing another object (or a class with sub-classes) which preserves all the features for knowledge items disclosed in the GKMS patent. This means that kitem objects can be generated without programming. The other features disclosed in the GKMS patent also apply to kitems implemented as classes.

Kitems can be linked. A link has a source or origin kitem and a destination kitem. The links can be stored inside the kitem or kuark, as a property of the kitem. An alternative is to store inside the kitem the address of the ‘link kitem’, that is, the kitem that is designed to contain the links that relate to a source kitem.

A multi-kuark or multi-kitem system may comprise a serial arrangement, in which the destination context of one kitem is used as the source context (or part of the source context) of another. More than two kitems can be chained.

Alternatively, a parallel kitem is made of kitems that have independent (or disjointed), but can also have overlapping, source contexts. Inside a parallel kitem, the component kitems are treated as peers, and links are defined between peers.

An application or knowledge base may comprise a set of knowledge items, kitems, defined with respect to a domain of discourse, where the kitems are arranged in parallel. Some of the kitems may be linked in series or in parallel.

A kitem may be a class that supports the creation of objects, or knowledge elements, where the kitem has access to all the properties and methods of other kitems contained within it, in addition to the properties that belong only to that kitem. Such a kitem is referred to as a ‘meta-kitem’ and is able to express meta-knowledge.

A display kitem is a serial kitem comprising two kuarks. The first kuark is a relevance kuark. It uses its region and the state of the environment to determines the relevance of the display kitem. The second kuark is a procedure kuark and has the relevance (the output of the first kuark) as source context and region. The material to be displayed comprises the destination region and the explanation.

An executable kitem is a serial kitem comprising two kuarks. The first kuark is a relevance kuark. It uses its region and the state of the environment to determines the relevance of the executable kitem. The second kuark is a procudure kuark. It has the relevance (the output of the first kuark) as region and as part of its source context. When the relevance is not ‘null’, the second kuark executes its mapping to produce the destination region. The inputs to the executable mapping are elements of the second kuark's source context that can be additional to the relevance context.

A knowledge item is a kitem comprising a source context, a source region, a destination context, a destination region, a mapping and an explanation.

Searching involves identifying those kitems that have source regions compatible with the enquiry. It means determining the ‘relevance status’(available, candidate, rejected or definite) of a kitem with respect to the enquiry or consultation so far. Searches may be synchronous or asynchronous. An available status is the default status of a kitem before a search takes place; a candidate kitem is one that is not incompatible with the enquiry so far; a rejected kitem is one that is incompatible with the enquiry so far and a definite kitem is one for which the enquiry satisfies the source region.

The source context may be organised as a tree structure. Each kitem may be indexed against the context tree. This means that each object in the context possesses a list of the kitems it is associated with. During processing, all the indexed kitems to the questions (context objects) asked and answered so far in the consultation have their relevance status checked and modified if appropriate. Kitems which become definite can be presented to the user, candidates remain contenders for definite status depending on future answers, and rejected items will not be considered any longer.

At the implementation level, the context tree is a modified context space kitem. The enquiry process instantiates a consultation kitem at each iteration, which contains the list of the linked kitems affected by the enquiry, with their states. These kitems affected are the available or candidate kitems in the knowledge base after the previous iteration, or all the kitems in the knowledge base is the enquiry searches the whole database at each iteration. The search process updates the status of the kitems according to the enquiry.

Alternatively, the search process (also a kitem) may flag the elements in the context tree that correspond to the questions answered so far. Each context tree element is itself a kitem and its role is to determine whether all the indexed elements have taken into account the values of the context tree element. If they do this, it passes the value(s) to the indexed kitems and waits until all the responses have been received.

The search process waits until all the tree elements corresponding to the enquiry so far have replied. When all have replied, the enquiry has been processed (the knowledge elements have determined their status based on the enquiry so far). Synchronisation is assured and the next step in the enquiry (presenting the results to the user and waiting for its input) can proceed.

At the implementation level, the context tree is a modified context space kitem. The enquiry process instantiates a consultation kitem at each iteration, which contains the list of the linked kitems affected by the enquiry, with their states. These kitems affected are the available or candidate kitems in the knowledge base after the previous iteration, or all the kitems in the knowledge base is the enquiry searches the whole database at each iteration.

Each kitem updates its status according to the enquiry and informs the searc process.

Alternatively, in asynchronous searches, the source region may determine whether the outcome of the kitem becomes applicable. That is, the source region determines the state of the kitem's relevance status and, depending on its state, the mapping becomes applicable. The state of the relevance region determines what happens to the application region.

Where each kitem has a unique ID or address that determines its location in a distributed memory space or network, it may also possess a set of applicability addresses that correspond to the kitems in its source region. During processing, the enquiry process may submit each answer to all the kitems which have, in their list of applicability addresses, the ID of the kitem that formed the question.

In this model, each kitem determines by itself whether it can fire or not:

the enquiry process submits its answers to the network; the answers reach the kitems that have the corresponding addresses in their applicability list (the kitems that form the source region);

the kitems update their relevance status with respect to this enquiry;

if the relevance status is definite or candidate, the kitem sends its ID and its status to the enquiry process.

The enquiry process, when submitting, sends its (return) address, an enquiry number and an enquiry step number. These numbers are returned by the kitems that reply and this enables the enquiry process to know what replies correspond to what enquiry (or enquiry step).

Each kitem can decide whether to answer more than once to an enquiry from the same origin or process. It is up to the enquiry process to manage all the replies it gets from the network.

The solution outlined here is applicable to distributed processing.

Another model for asynchronous searches is to give even more responsibility to the distributed kitems, and each kitem has the address of each of the context objects in its context and in its region (a subset of the context). The kitem interrogates the network at regular interval to determine whether the status of the region, and hence of the applicability of the kitem, has changed.

Cascading refers to a knowledge element having, as part of its destination region, an object that belongs to the source region of another knowledge element. When the first knowledge element fires, it may change its source region in a way that impact on the applicability of the second knowledge element. The second knowledge element may have to fire, not as a direct effect of the enquiry but as an indirect effect, that is, a consequence of another knowledge element having changed its state. This process can extend to any arbitrary number of knowledge elements, called cascading knowledge elements.

In order to ensure that all the cascaded elements update their state if appropriate, it is necessary to a) link the cascaded elements, and b) have the search process update the relevance status of these cascaded knowledge elements (synchronous search) or c) to communicate the state of the environment (outputs of previously fired knowledge elements) to the linked cascaded knowledge elements (asynchronous search).

In a multi-kitem system, knowledge processing involves running a question-answer session. The system asks questions, get answers and, on the basis of these answers, asks further questions until the correct answers are found or no answers exist. The steps involved are:

identifying the most important questions (the importance is determined by the ability of the answers to the question to lead to the correct answers as quickly as possible);

asking these questions;

on the basis of the answers to the questions, determining whether any answers can be found, and the next best questions to ask.

Identifying the most promising questions may involve a synchronous search through a context tree with processing delegated to a search agent. As the context tree is updated each time a question is considered, the most important questions to ask next depend on the consultation so far; that is, on the state of the context tree after the previous enquiry has been processed. Therefore the questions are selected dynamically.

Alternatively the search may have processing delegated to each kitem. Context tree search with processing delegated to each kitem As explained above, the search process waits until all the tree elements corresponding to the enquiry so far have replied. It is the responsibility of the enquiry process to collect these replies and to count the number that come from each of the tree context element:

it waits for answers to get back from the network;

it counts the number of candidate kitems from each context tree element—the ones with the highest number of candidate kitems correspond to the best questions to ask.

In addition, the enquiry process may perform the following operations:

it can pass the kitems it received to the display kitem (that will display them according to their relerance status), this process can also be asynchronous it can build its own operational domain of discourse (source and destination context spaces) by concatenating the context spaces of all the answers received so far.

In an asynchronous searches the enquiry process (that sends the enquiry over the network for kitems to process it) may perform several tasks:

it waits for answers to get back from the network;

it counts the number of candidate kitems from each context tree element—the ones with the highest number of candidate kitems correspond to the best questions to ask.

In addition, the enquiry process may perform the following operations:

it can pass the kitems it received to the display kitem (that will display them according to their relevance status), this process can be asynchronous;

it can build its own operational domain of discourse (source and destination context spaces) by concatenating the context spaces of all the answers received so far.

In situations where the domain of discourse of a body of knowledge is known, one can identify the kitems with the largest number of indexed kitems with relevance status available or candidate in order to find hidden knowledge.

The process of producing a context tree is a compilation of the kitems in an application or domain of discourse. Compilation keeps the identity of the kitems and all the data and information in these kitems that pertain to their execution. Keeping the identity of these kitems enables the non-executable parts of the kitems to be retrieved at execution time on a ‘as needed’ basis.

There are two types of compilation:

Just-in-time compilation imposes the compiled kitem to take the latest version of each kitem in its process, in particular the latest version of the source and destination regions; or

Permanent compilation accepts that the kitems do not change (between compilations) and that their attributes and methods can be used without checking them. Therefore they are included in the compiled kitem. This is faster than the partial compilation.

An agent may be represented as a kitem with the following structure: Beliefs 61, Desires 62 and Intentions 63 are parallel kitems (their respective components are also kitems);

the Beliefs 61, Desires 62 and Intentions 63 kitems are organised in a serial architecture. That is, the agent kitem is a serial kitem;

the destination and output region of the Beliefs kitem map on the source and source region of the Desires kitem;

the destination and output region of the Desires kitem map on the source and source region of the Intentions kitem.

The kitems needed to produce a workable implementation for knowledge management are shown below:

A context element is a display kitem (a serial kitem made of two kuarks).

A source or destination context kitem is a parallel display kitem. Its members comprise the list of all the context elements defined in the domain of discourse.

Context executable kitems may edit a context element, edit a context space or display a context space as a tree.

A source or destination context tree is an executable kitem. The display kitem may display the elements that belong to the source and destination kitems. Its source context is the source or destination kitem and its destination context is the visual tree-like representation of the context.

A knowledge editing kitem is an executable kitem that has:

As source space: the source and destination contexts.

As destination space: the source and destination contexts.

As source region: a subset of the source context that defines the applicability of the knowledge kitem.

As mapping:

a link to a subset of the destination context, or

a procedure or executable (sub-)kitem.

As destination region:

a subset of the destination context that defines the outcome of the mapping, or

the outcome of the procedure.

An explanation.

A search kitem is an executable kitem with:

as source context: the source and destination contexts;

as source region: the enquiry as defined so far;

as destination context: the kitems in the domain of discourse (if known);

as mapping: the search process that identifies the candidate and definite kitems with respect to the enquiry;

as destination region: the candidate and definite kitems ‘retrieved’ by the mapping.

An enquiry kitem is an executable kitem with:

as source space: the enquiry (the consultation process, showing each step in the question-answer session);

as destination space: the status of the enquiry (answered, not answered, etc.), the ids of the definite kitems.

A display kitem is an executable kitem with:

as source space: the kitems to be displayed (itself another kitem); the display parameters;

as destination space: the code that puts the kitems on the screen in a hierarchical way.

This technology supports rapid application development (RAD). RAD is a very important commercial feature for software. It holds the promise of speeding up software development, implementation and customization. RAD, or any significant progress in this area, has the potential to save, worldwide, enormous sums (billion of dollars) in development, and to reduce the total cost of ownership of software solutions over their lifetimes. RAD is also a very serious technical challenge for designers.

Agents hold the promise of autonomous and intelligent software that is capable of co-operating with other agents (and human beings) towards achieving a goal. In addition agents, with proper architecture, should scale up. That is, they could provide a promising platform for building complex, adaptable systems that could have knoweldge and perhaps exhibit intelligent behaviour. Currently agents are difficult to design and buid. This is because agents draw on several disciplines, each one bringing its own theoretical and practical difficulties to design and development. They are: control theory, cognitive psychology and artificial intelligence.

### BRIEF DESCRIPTION OF THE DRAWINGS

The background to the invention has been described above with reference to the following drawings:

FIG. 1 is a diagram illustrating knowledge as mappings between a problem space and a solution space.

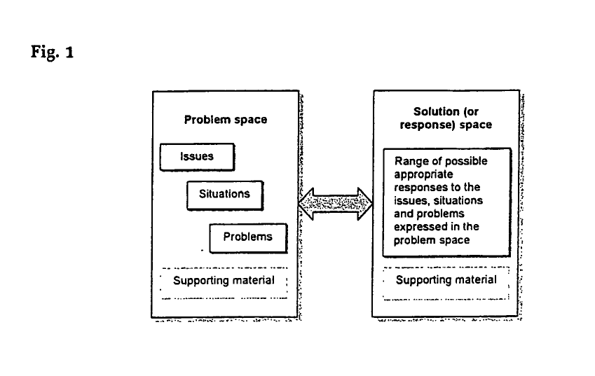

FIG. 2 is a diagram illustrating a network of client-servers, each able to run agents.

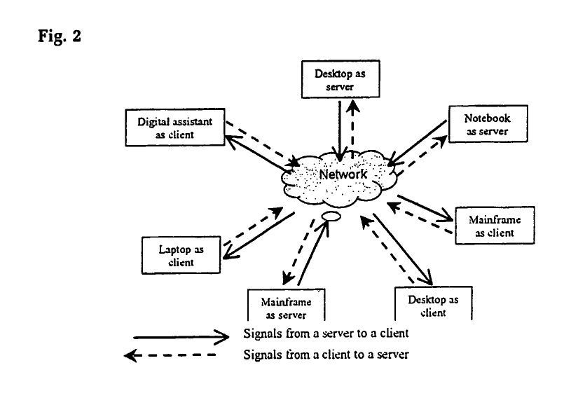

FIG. 3 is a diagram illustrating a knowledge capture loop in the GKMS.

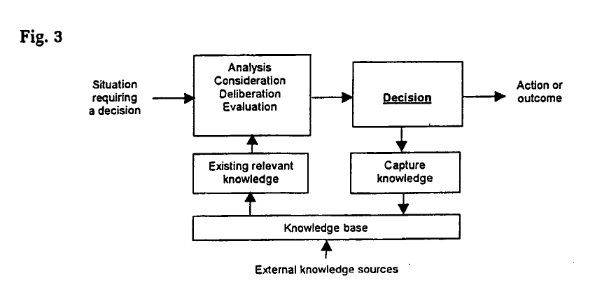

FIG. 4 is a diagram illustrating an expanded knowledge capture loop in an on-the-job problem-solving system.

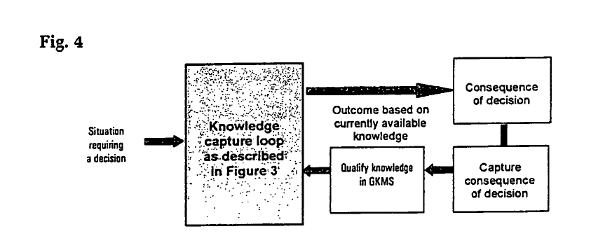

FIG. 5 is a diagram illustrating the agent DBI model.

FIG. 6 is a diagram illustrating an agent situated in and interacting with its environment.

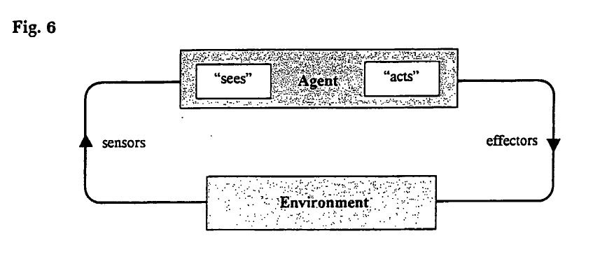

The invention will now be described with reference to the following drawings:

FIG. 7 is a diagram illustrating a generic elementary cognitive element (kuark).

FIG. 8 is a diagram illustrating a relevance kuark.

FIG. 9 is a diagram illustrating a procedure kuark.

FIG. 10 is a diagram illustrating a serial architecture.

FIG. 11 is a diagram illustrating a parallel architecture.

FIG. 12 is a diagram illustrating the agent implementing the DBI model as a serial kitem.

### BEST MODES OF THE INVENTION

Generic Elementary Cognitive Agent (Kuark)

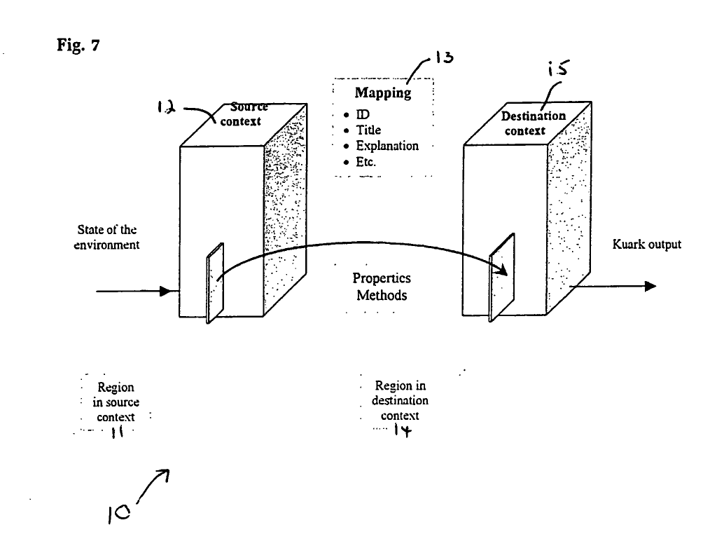

Referring to FIG. 7, the generic elementary cognitivey agent (kuark) 10 is the building block of agent-based applications. The kuark knowledge model implements and extends the GKMS model described in the GKMS patent.

The kuark 10 monitors the environment by detecting all environment parameters compatible with the source region 11 and source context 12. When the source region 11, which determines the applicability of the mapping 13, is satisfied, the mapping 13 fires. The mapping determines the output region 14 in the destination context 15 and makes the region available to the output, and hence to the environment. Regions are sometimes referred to as patterns.

### EXAMPLE 1

The source context comprises two sets of integers and the destination context one set of integers. The source region is the positive integers for the two sets, the mapping a multiplication of the two inputs accepted in the source region. The destination region is the result of the multiplication of the two positive numbers.

### EXAMPLE 2

The source context is the state of a logical variable and the region the value ‘true’ of that variable. The destination context is the state of the same variable and the mapping the ‘negation’ of the original value, that is ‘false’.

### EXAMPLE 3

The source context is the temperature and pressure inside a boiler and the destination context a list of commands triggering alarms and associated processes (that can be software based). The source region is the range of pressures and temperatures that trigger a ‘code red’ alert and the destination region the command triggering the ‘code red’ alarm.

### EXAMPLE 4

The source context and region is as in the example 3. The destination context is the list of the relevance status of the kuark and the region the actual relevance status of the kuark, based on the source region. That is, the ‘code red’ alert is given a relevance status (perhaps expressed as a probability) based on the environment.

Kuark Properties

The common properties of a kuark are:
univeral id;
title;
explanation (multimedia);
time and date created;
author;
time and date when last modified;
person who last modified agent;
version number;
domain of discourse
source context (what it knows about) 12;
destination context 15;
applicability
source region or pattern 11 (can be identical to source context);
relevance status to an enquiry (available, candidate, rejected, definite);
mapping 13 (the process that produces the outcome based on the state of source context)
outcome
result of the mapping between source and destination context;
the mapping determines the destination region or pattern;
status (enabled/disabled/archived);
state of source context at time of last firing (describes source context and region);
state of destination context after last firing (describes destination region);
links to other kuarks
the hierarchical parent's universal id (more than one parents could be allowed);
the id of the previous version kuark;
the ids of the kuarks that are part of this kuark (see later for multi-kuark kuarks);
the ids of the kuarks this kuark belongs to or is associated with (see later for multi-kuark kuarks).
The property ‘links to other kuarks’ is the mechanism used to implement relationships between kuarks. The fourth link mentioned may be implemented as separate kuark(s) designed to contain the IDs of the kuarks the kuark in question relates (or belongs) to.

Kuark Methods

The main methods of a kuark are:
monitor applicability (detect only what its context allows);
determines whether environment fits within source region, if yes triggers/fires mapping;
execute mapping (modifies destination state)
mapping determines the outcome which is a subset of the destination context;
create daughter/parent kuark;
adopt existing kuark as daughter or parent;
display internal state (contexts, regions, mapping);
make copy each time it fires.

It is possible to implement these methods outside the current kuark, in a separate class or subroutine for example.

Relevance Kuark

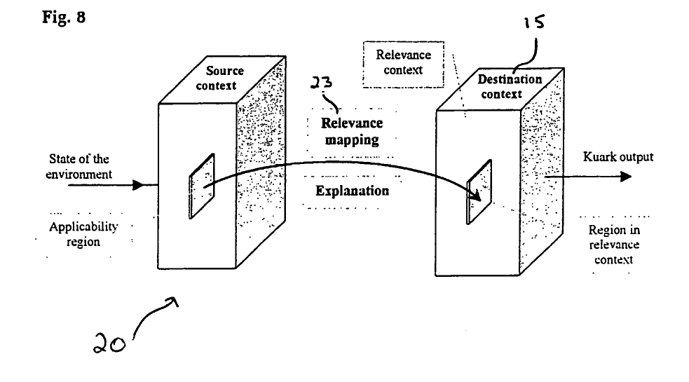

Referring now to FIG. 8, a relevance kuark 20 is a kuark 10 (as described previously) that determines the relevance of the environment. Depending on the the state of the environment with respect to the source context and source region, the kuark fires a relevance mapping 23 that determines (calculates) the relevance of the environment. The relevance can be expressed as a probability. The destination context 15 is made of the different relevance values that the environment can take with respect to the source context and region. For example, the values could be ‘definitely relevant’, ‘possibly relevant’, ‘relevant’, ‘likely not relevant’, ‘not relevant’.

Procedure Kuark

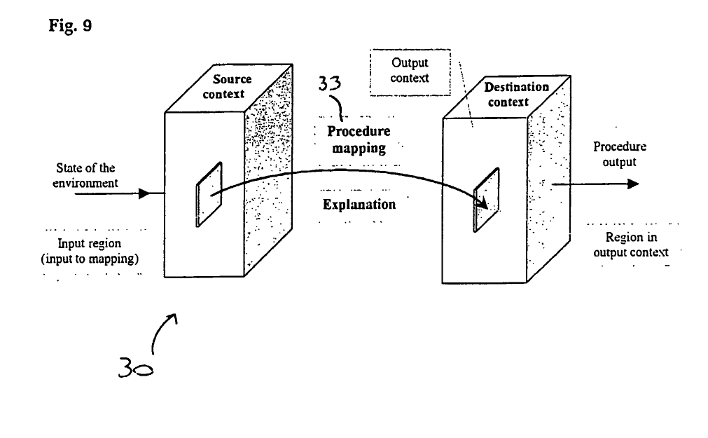

Referring now to FIG. 9, a procedure kuark 30 is one that contains a (usually small) program or procedure that takes as input some elements of the source context and produces, as output, a pattern that fits within the destination context.

The kuark executes its procedure mapping 33, when the environment is compatible with the source context and the region. That is, the input to the procedure is the source region in the source context. The destination context describes the range of outputs the procedure can produce when run, and the destination region or pattern is the actual result of the execution of the mapping, using an instance of the environment.

The procedure mapping can be a trivial mapping. It can simply display a fixed pattern and an explanation in a fixed destination context. The context item, see later, is an implementation of the trivial procedure kuark.

Relevance kuarks tend to have the same destination context, whereas procedure kuarks typically have context that are strongly application dependent and that can vary within an application.

Kuarks and Object Oriented Programming

Kuarks can be implemented as classes and objects using an object oriented language such as Java. A kuark is a class in OOP and some of its properties are static, final, etc.

A kuark that is given values for its source and destination contexts and regions are objects or instances of the corresponding kuark class.

Multi-Kuark Systems or Applications

This section describes how kuarks can be used together to increase the power of applications.

Multi-Kuark Kitems

A system made of several kuarks is still a kuark with all the allowed properties and methods. However, the term kuark is reserved for simple (or elementary) kuarks, as described above. A multi-kuark kuark is named a kitem.

Kitems are constructed as follows:
the designer identifies the kuarks (or kitems) to be included in the new kitem;
the designer clicks ‘construct kitem’.

The construction process simply puts a wrapper around the kuarks and kitems to include in the new kitem. All the component kuark and kitems keep their identities. The new kitem can have its own properties and methods in addition to those of its component kitems. The new kitem has its own title and explanation, and can also have its own source and destination contexts and regions, and its own mapping.

One can also view the new kuark as having undergone a construction process that carried the following operations:
concatenates the source contexts;
concatenates the destination contexts;
concatenates the source regions;
concatenates the destination regions;
concatenates the mappings;
concatenates the explanations.

Here concatenates means ‘take the union’ of the entities in question; for mappings, it is the juxtaposition of the individual mappings. The kitem construction process also builds the list of kuarks or kitems that are part of the new kitem.

Typically, when a kitem is built, all its components (kuarks or kitems) keep their individual contexts. Alternatively the kitem construction process can also be set so that all components get the same source and destination contexts, that is the concatenation of the individual contexts of the kitem components.

Kitems have explicit domains of discourse, the source and destination contexts, and explicit regions; kitems are ‘aware’ of their domains of discourse and when their knowledge, expressed as their mappings and destination regions, can be applied.

Not all kuarks can be assembled in kitems as some concatenation may not be allowed; this issue is not treated further here.

Refer later for different architectures for multi-kitem systems.

Kitem Hierarchy

When defining kitems for an application, it is often convenient to organise them as a hierarchy of objects, as in a file system for example. In fact, all kitems are defined within a hierarchical structure similar to that of the domain names on the Internet. Each kitem has a parent, except the root kitem which is the top of the tree.

The hierarchical organisation of the kitems imposes no restriction on how they can be grouped (in multi-kitem systems) to achieve some purposes in an application. That is, composed kitems can be assembled out of any kitem from any location in the hierarchy.

Kitems and Object Oriented Programming

A kitem as outlined above, together with its GKMS features, mean that kitems can be implemented using an object oriented language, as objects or instances of the kuark or kitem classes.

As indicated above, a kuark or kitem can be represented as an object using an object oriented language such as Java. A multi-kuark kitem as outlined above, can be expressed as an object containing another object (or a class with sub-classes) which preserves all the features for knowledge items disclosed in the GKMS patent. This means that kitem objects can be generated without programming. The other features disclosed in the GKMS patent also apply to kitems implemented as classes.

Rationale for Multi-Kitem Systems

The advantages of building applications using kitems are very significant:
the methods and properties can be used across the hierarchy (for example, a method to display the components kitems of a kitem can be re-used at all levels in the hierarchy of kitems);
kitems provide a unified way for thinking and implementing applications;
kitems can be fashioned as simple building blocks that offer maximum re-use;
kitems implement knowledge at every level (in every kitem) that make up the application;
knowledge permeates the design and the use of the application;
applications can be largely soft-coded, instead of hard-coded;
applications can be developed rapidly (RAD: rapid application development).

Links Between Kitems

Kitems can be linked. A link has a source or origin kitem and a destination kitem. The links can be stored inside the kitem or kuark, as a property of the kitem. An alternative is to store inside the kitem the address of the ‘link kitem’, that is, the kitem that is designed to contain the links that relate to a source kitem.

In a link kitem, the source context contain the ID of the source kitem and the type of link (see above for list of possible links), and the destination regions contains the IDs of the corresponding links (the destination context is the domain of discourse of the source kitem).

It is also possible, indeed often preferable, to have the source and destination contexts and regions for a kitem expressed via links. That is, one or several link kitems contain the source and destination context, and the regions (their kitems and values).

Multi-Kitem Architectures

This section discusses the architectures available for building multi-kuark or multi-kitem systems. In particular, these architectures can be used to build the display and executable kitems.

Serial Architecture

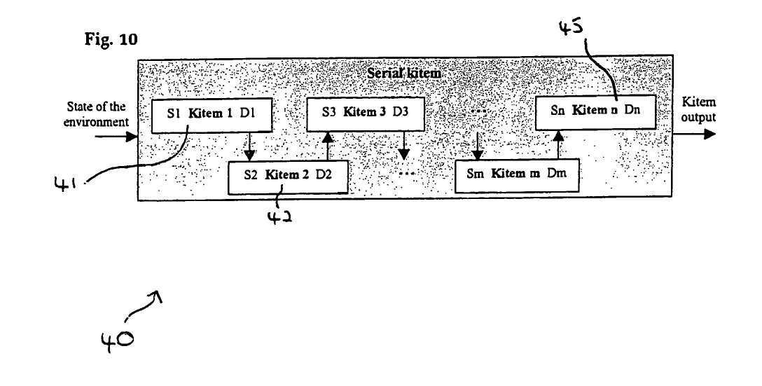

In the serial architecture 40, the destination context of one kitem 41 is used as the source context (or part of the source context) of another 42. More than two kitems can be chained, as illustrated in FIG. 10.

The state of the environment is used as input to kitem 41 (and perhaps to other kitems). Similarly, the serial kitem output is the output from kitem n 45 (and perhaps from other kitems). In the most simple case, the source context is the source context of kitem 41 and the destination context the destination context of kitem n. In general, the source context of the serial kitem is a subset of the source contexts of all its ‘internal kitems’. Similarly for the destination context and for the regions in these contexts. The source context of an internal kitem can comprise some elements from the environment in addition to the output from the previous kitem.

The serial kitem is a kitem and has all the properties of kitems discussed above.

Parallel Architecture

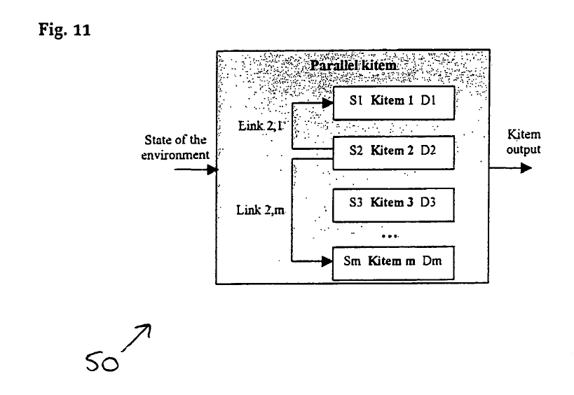

Referring now to FIG. 11, a parallel kitem 50 is made of kitems that have independent (or disjointed), but can also have overlapping, source contexts. The power of parallel kitems derives from the links that can be established between its internal kitems. The objective is to ensure that the information and knowledge contained in two kitems becomes linked. For example, a kitem could describe clients and another projects; and a link would connect a client with a project. A link has an origin and a destination.

Inside a parallel kitem, the component kitems are treated as peers, and links are defined between peers.

When the class of a parallel kitem is defined, the operator has to specify which kitems are instantiated as objects when the parallel kitem object is created. In linked kitems, it is convenient, but not mandatory, to instantiate the origin kitem but not the destination kitem.

Links can be unidirectional or bidirectional. For example, from clients to projects, or from clients to projects and from projects to clients.

Hierarchical Kitems

The kitems that are part of a parallel (or serial kitem) keep their properties, notably the one identifying their parents. Therefore the parallel kitem can, in fact, contain a hierarchy of kitems even if they are organised in a flat hierarchical (that is, parallel) way in the parallel kitem.

A Knowledge Application as A Parallel Architecture Kitem

An application or knowledge base is a set of knowledge items (kitems) defined with respect to a domain of discourse (source and destination contexts and mappings available). These kitems are arranged in parallel and some of them can be linked. For example, in an application all the knowledge items are typically linked (that is refer) to the same domain of discourse, as explained above.

Hybrid Architecture

It is possible to define a hybrid architecture, with the hybrid kitem containing some kitems linked in a serial way and others in a parallel way.

Meta-Kitems and Meta-Knowledge

In FIGS. 10 and 11, each kitem is a class that supports the creation of objects, or knowledge elements. It is desirable to be able to define a class that can have attributes and methods that span more than one of the kitems contained in the parallel, serial or hybrid kitem. This can be achieved by giving the outside kitem (eg: the serial, parallel or hybrid kitem) access to all the properties and methods of the contained kitems, in addition to the properties that belong only to the outside kitems.

This means that it is possible to define meta-knowledge about the kitems contained in the outside kitems. The outside kitem, when instanced as an object, can observe the behaviour of the kitems in it and take actions when necessary. The outside kitems are referred to as meta-kitems able to express meta-knowledge.

Display and Executable Kitems

In this section we consider two different types of very useful kitems: the display kitem and executable kitem. We show that each can be constructed using one relevance kuark and one procedure kuark.

Display Kitem

The display kitem is a serial kitem comprising two kuarks. The first kuark is a relevance kuark. It uses its region and the state of the environment to determines the relevance of the display kitem. The second kuark has the relevance (the output of the first kuark) as source context and region. The material to be displayed comprises the destination region and the explanation (the destination region can be the explanation.

Context Kitem

Contexts and regions are made of elements or objects that describe the contexts and regions. Each such object can have values. Here we show that kitems are suitable for describing and implementing these context objects. A context object is a kitem as shown below (only some properties are mentioned):

| | | |
|---|---|---|
| kitem tile | → | object title |
| source context | → | object values |
| source region | → | instantiated values |
| destination context | → | same as source context |
| destination region | → | same as source region |
| mapping | → | maps source to destination |
| (contexts and regions) | | |
| explanation | → | optional. |

Explanation Kitem

An explanation object is a kitem as shown below (only some properties are mentioned):

| | | |
|---|---|---|
| kitem title | → | explanation title (can be |
| | | ‘explanation’) |
| source context | → | not used |
| source region | → | not used |
| destination context | → | not used |
| destination region | → | not used |
| mapping | → | not used |
| explanation | → | multimedia explanation. |

Context Element

A context element is a kitem made of, typically, a context kitem and an explanation kitem (some context items can have more than one explanation). To create such a kitem, the designer defines a parallel kitem using the procedure described in the GKMS patent.

It is also possible to have a context item made of a single context kitem, by using its explanation instead of the explanation kitem. This solution does not work if more than one explanation is required. For example, an explanation relating to the meaning of the context item and another relating to its use in a knowledge item.

Context Space (Source Or Destination)

The context space is a kitem made of context items (also kitems) using the parallel architecture. Typically no links are used between context items.

Executable Kitem

The executable kitem is a serial kitem comprising two kuarks. The first kuark uses its region and the state of the environment to determines the relevance of the executable kitem. The second kuark has the relevance (the output of the first kuark) as region and as part of its source context. When the relevance is not ‘null’, the second kuark executes its mapping to produce the destination region. The inputs to the executable mapping are elements of the second kuark's source context that can be additional to the relevance context.

Knowledge Item and Knowledge Item Definition

A knowledge item is a kitem comprising a source context, a source region, a destination context, a destination region, a mapping and an explanation.

Defining a knowledge item, as described in the GKMS patent, involves defining a region in the source context (and other things). This is done using the context space kitem, that is made of context objects (or elements). The architecture of a knowledge item is normally that of a parallel kitem.

It is often desirable to explain why a certain context element is part of a knowledge item or how to use or interpret this context element when it is attached to the knowledge item. This can be achieved simply by giving the user defining the knowledge item the facility to add an explantion kitem to the list of kitem that are part of the knowledge item, and linking this explanation kitem to the context element (kitem) in question. Alternatively, the explanation can be part of the context element kitem. That is, the explanation kitem is already linked to the context element (with reference to OOP, the context element class ‘contains’ the explanation).

A knowledge item is defined with respect to a domain of discourse, defined by the source and destination context and the mappings available at definition time. It would not be efficient to include the contexts kitems in the knowledge item. Instead, the knowledge item is linked to the context space kitems. This is in agreement with the definition of links in the parallel architecture kitem.

Kitem Hardcoding

We have discussed how kitems can be implemented using other kitems. However it is always possible to implement a kitem as a single hardcoded entity. For example, in the GKMS patent, the context elements and the knowledge items were implemented as single entities with their specific architectures. When this is done, many of the modular and flexible features of the kuark-kitem model are lost.

When a similar effect is desired, it is preferable to implement the kitem as a permanently compiled multi-kitem kitem (see later).

Knowledge Processing in Multi-Kitem Systems

A multi-kitem system is a system comprising a set of kitems representing the body of knowledge about a certain domain of discourse. Typically the domain of discourse is identical for all the kitems in the system, although it is not essential. Such a system is identified as a knowledge module or database.

Knowledge processing involves the system (or server) running a question-answer session. The system asks questions, get answers and, on the basis of these answers, asks further questions until the correct answers are found or no answers exist. The steps involved are:
identify the most important questions (the importance is determined by the ability of the answers to the question to lead to the correct answers as quickly as possible);
asks these questions;
on the basis of the answers to the questions, determine a) whether any answers can be found, and b) the next best questions to ask.

The processing refers to:
the identification of the correct answers available in the knowledge base, on the basis of the information available so far in the consultation; and
the identification of the most promising provisional answers available in the knowledge base, on the basis of the information available so far in the consultation; and
the identification of the most important questions to ask on the basis of the information available.

Searching for relevant or important knowledge

Knowledge access in a multi-kitem system (a knowledge module) follows the same pattern as for a GKMS knowledge base; that is, it is a question-answer session or consultation. The consultation process is managed with, and recorded in, a document. This document can also be a kitem called the consultation kitem. That is, the consultation kitem has all the properties and methods of the kitem class. All the utilities for kuarks and kitems can be used with consultation kitems.

Searching involves identifying those kitems that have source regions compatible with the enquiry (see GKMS patent for meaning of compatible). It means determining the ‘relevance status’ (available, candidate, rejected or definite) of a kitem with respect to the enquiry or consultation so far. Searches can be synchronous or asynchronous. An available status is the default status of a kitem before a search takes place; a candidate kitem is one that is not incompatible with the enquiry so far; a rejected kitem is one that is incompatible with the enquiry so far and a definite kitem is one for which the enquiry satisfies the source region.

Synchronous Searches

Database Search

The database search is a SQL search or equivalent. This means that the kitems are stored as records in a database. This is not discussed further in this document

Full Text Search

The full text search has to process each relevant field in each record where each record describes a knowledge element. This process can be slow; it is not discussed further in this document.

Context Tree Search with Processing Delegated to A Search Agent

The source context is organised as a tree structure. A source region, which determines whether a kitem will fire (firing depends on the region's compatibility with an enquiry), is a subset of the source context. Each kitem (eg: knowledge element) can be indexed against the context tree. This means that each object in the context possesses a list of the kitems it is associated with. The context tree is a formalisation of one of the kuarks'properties (see above).

During processing, all the indexed kitems to the questions (context objects) asked and answered so far in the consultation have their relevance status checked and modified if appropriate. Kitems which become definite can be presented to the user, candidates remain contenders for definite status depending on future answers, and rejected items will not be considered any longer.

At the implementation level, the context tree is a modified context space kitem. The enquiry process instantiates a consultation kitem at each iteration, which contains the list of the linked kitems affected by the enquiry, with their states. These kitems affected are the available or candidate kitems in the knowledge base after the previous iteration, or all the kitems in the knowledge base is the enquiry searches the whole database at each iteration. The search process updates the status of the kitems according to the enquiry.

Context Tree Search with Processing Delegated to Each Kitem

The search process (also a kitem) flags these elements in the context tree that correspond to the questions answered so far. Each context tree element is itself a kitem and its role is to determine whether all the indexed elements have taken into account the values of the context tree element. If they do this, it passes the value(s) to the indexed kitems and waits until all the responses have been received.

The search process waits until all the tree elements corresponding to the enquiry so far have replied. When all have replied, the enquiry has been processed (the knowledge elements have determined their status based on the enquiry so far). Synchronisation is assured and the next step in the enquiry (presenting the results to the user and waiting for its input) can proceed.

At the implementation level, the context tree is a modified context space kitem. The enquiry process instantiates a consultation kitem at each iteration, which contains the list of the linked kitems affected by the enquiry, with their states. These kitems affected are the available or candidate kitems in the knowledge base after the previous iteration, or all the kitems in the knowledge base is the enquiry searches the whole database at each iteration. Each kitem updates its status according to the enquiry and informs the searc process.

Asynchronous Searches

Processing Delegated to Each Kitem

In asynchronous searches, the processing is distributed and controlled by each item. There is no central authority that decides what to do when. Each kitem (or agent) monitors its environment and reacts appropriately. In doing so, it may change the environment and trigger new actions by other kitems.

This is in contrast to synchronous searches in which it is the search process that determines whether a kitem is applicable or not. In particular, in asynchronous searches it is each kitem that determines whether it is applicable to the environment as it is detected via the source context and the source region.

In asynchronous searches, the source region determines whether the outcome of the kitem becomes applicable. That is, the source region determines the state of the kitem's relevance status and, depending on its state, the mapping becomes applicable. The state of the relevance region determines what happens to the application region.

In the case of non-executable mappings (or display mappings) the process is as illustrated in FIG. 8; the relevance mapping ‘releases’ the destination region to the kuark output.

State of Environment (or Context) Communicated to the Items

As indicated above, each kitem has a unique ID or address that determines its location in a distributed memory space or network (such as the Internet for example). It also possesses a set of applicability addresses that correspond to the kitems in its source region. During processing, the enquiry process submits each answer to all the kitems which have, in their list of applicability addresses, the ID of the kitem that formed the question.

In this model, each kitem determines by itself whether it can fire or not:
the enquiry process submits its answers to the network;
the answers reach the kitems that have the corresponding addresses in their applicability list (the kitems that form the source region);
the kitems update their relevance status with respect to this enquiry;
if the relevance status is definite or candidate, the kitem sends its ID and its status to the enquiry process.

The enquiry process, when submitting, sends its (return) address, an enquiry number and an enquiry step number. These numbers are returned by the kitems that reply and this enables the enquiry process to know what replies correspond to what enquiry (or enquiry step).

Each kitem can decide whether to answer more than once to an enquiry from the same origin or process. It is up to the enquiry process to manage all the replies it gets from the network.

The solution outlined here is applicable to distributed processing.

The Kitems Seek to Know the Status of their Source Context

Another model for asynchronous searches is to give even more responsibility to the distributed kitems than in the previous description. In this model, each kitem has the address of each of the context objects in its context and in its region (a subset of the context). The kitem interrogates the network at regular interval to determine whether the status of the region, and hence of the applicability of the kitem, has changed.

This model means that the kitem takes the intiative (this has some important applications not discussed here). However during searching, the model imposes much traffic on the network that is of no benefit, unless the context object has changed since the last status check. Another problem is that there may be an unacceptable delay between status checks, during which time, if the status has changed, the kitem doing the interrogating cannot determine its applicability.

Cascading Knowledge

Cascading refers to a knowledge element having, as part of its destination region, an object that belongs to the source region of another knowledge element. When the first knowledge element fires, it may change its source region in a way that impact on the applicability of the second knowledge element. The second knowledge element may have to fire, not as a direct effect of the enquiry but as an indirect effect, that is, a consequence of another knowledge element having changed its state. This process can extend to any arbitrary number of knowledge elements, called cascading knowledge elements.

In order to ensure that all the cascaded elements update their state if appropriate, it is necessary to a) link the cascaded elements, and b) have the search process update the relevance status of these cascaded knowledge elements (synchronous search) or c) to communicate the state of the environment (outputs of previously fired knowledge elements) to the linked cascaded knowledge elements (asynchronous search).

Validity of the Relevant Knowledge

For simple knowledge bases on a single server it is a relatively simple matter to ensure that all kitems they contain have the same domain of discourse. This, however, does not apply for large or distributed knowledge bases where the knowledge comes from different sources.

In general, therefore, there is no certainty that all the knowledge items (kitems) accessed during a search have the same source and destination contexts. In fact it is unlikely. This means that a user inspecting a definite kitem (with respect to an enquiry) may not know what the domain of discourse of that kitem might be. This information is very important as it defines the context for the knowledge in the kitem in question. A solution to this situation is to give the user the ability to inspect the source and destination context of every kitem that is provided by the search process either as a candidate or definite kitem.

Identifying the Most Promising Questions

Synchronous Searches

Context Tree Search with Processing Delegated to A Search Agent

Context objects which index a large number of available or candidate kitems are potentially very important when used as questions. This is because their answers have the potential to impact on the relevance status of a large number of kitems. This indicates that the importance of these context objects as questions in an enquiry is determined by the number of kitems with status available or candidate they index.

As the context tree is updated each time a question is considered, the most important questions to ask next depend on the consultation so far; that is, on the state of the context tree after the previous enquiry has been processed. Therefore the questions are selected dynamically.

Context Tree Search with Processing Delegated to Each Kitem

As explained above, the search process waits until all the tree elements corresponding to the enquiry so far have replied. It is the responsibility of the enquiry process to collect these replies and to count the number that come from each of the tree context element:
it waits for answers to get back from the network;
it counts the number of candidate kitems from each context tree element—the ones with the highest number of candidate kitems correspond to the best questions to ask.

In addition, the enquiry process can perform the following operations:
it can pass the kitems it received to the display kitem (that will display them according to their relerance status), this process can also be asynchronous
it can build its own operational domain of discourse (source and destination context spaces) by concatenating the context spaces of all the answers received so far.

Asynchronous Searches

Processing Delegated to Each Kitem

The enquiry process (that sends the enquiry over the network for kitems to process it) performs several tasks:
it waits for answers to get back from the network;
it counts the number of candidate kitems from each context tree element—the ones with the highest number of candidate kitems correspond to the best questions to ask.

In addition, the enquiry process can perform the following operations:
it can pass the kitems it received to the display kitem (that will display them according to their relevance status), this process can be asynchronous;
it can build its own operational domain of discourse (source and destination context spaces) by concatenating the context spaces of all the answers received so far.

Search for Hidden Knowledge

Hidden knowledge refers to knowledge that may be relevant to an enquiry but that is not yet linked to any question answered in the enquiry process so far. The question is how to identify this hidden knowledge and how to extract its ‘best questions’.

In situations where the domain of discourse of a body of knowledge is known, one can simply identify the kitems with the largest number of indexed kitems with relevance status available or candidate (see context tree above). There is no simple solutions when the domain of discourse of a body of knowledge is not known.

Processing Speed

Synchronous Searches

Context Tree Search with Processing Delegated to A Search Agent

Synchronous searches can be very quick as they are under the control of one process that can be optimised, based on known conditions in the server.

Context Tree Search with Processing Delegated to Each Kitem

This processing can be distributed across a network, but it is infrequent. This processing is slower than the previous one as it imposes communications overheads between kitems (those doing some processing and the enquiry process). Nevertheless, the enquiry process runs on a single server and can be optimised. When the process is distributed, several kitems can process simultaneously; this can partially offset the communication overheads.

Asynchronous Searches

Processing Delegated to Each Kitem

This processing is slowest unless the number of kitems doing processing is large enough to offset the communication overhead between kitems and the network delays.

Compilation

Compilation is the process that takes a collection of kitems and organises them for the purpose of speeding up processing. The result of compilation is a kitem. In general, compilation is applied to any kitem. In practice it is often applied to all the kitems that belong to a domain of discourse (also a kitem) on a single server. That is, all the kitems involved have domains of discourse that are subset of the compiled domain of discourse. Compilation is also applied to a group of kitems contained in a serial, parallel or hybrid kitem. The process of producing a context tree is a compilation of the kitems in an application or domain of discourse.

Compilation keeps the identity of the kitems and all the data and information in these kitems that pertain to their execution. Keeping the identity of these kitems enables the non-executable parts of the kitems to be retrieved at execution time on a ‘as needed’ basis.

The processing model for the multi-agent systems described in this document imposes, like the Java language, that kitems call other kitems that in turn may call other kitems, etc, until the processing can be completed. Once this is done, the results of the processing need to travel up the hierarchy of kitems, back to the initiating process.

The compilation process is designed to speed up the ‘down-hierarchy’ and ‘up-hierarchy’ travelling described above. The context tree compilation achieves this purpose by ‘flattening’ the hierarchy to a single branch tree, where each context element (or node) in the branch contains all the kitems that have that context element as part of their regions.

There are two types of compilation:
Just-in-time compilation imposes the compiled kitem to take the latest version of each kitem in its process, in particular the latest version of the source and destination regions; or
Permanent compilation accepts that the kitems do not change (between compilations) and that their attributes and methods can be used without checking them. Therefore they are included in the compiled kitem. This is faster than the partial compilation.

Compilation can be be carried out to different depths:

1. build context tree at runtime;

2. get regions of indexed kitems in the context tree at runtime;

3. include regions of indexed kitems in the context tree;

Compilations of type 1 and 2 above are just-in-time compilations. They updates the context tree each time the search process is triggered; permanent compilation produces the context tree and leaves it untouched until another compilation is carried out.

Agents as Kitem Systems

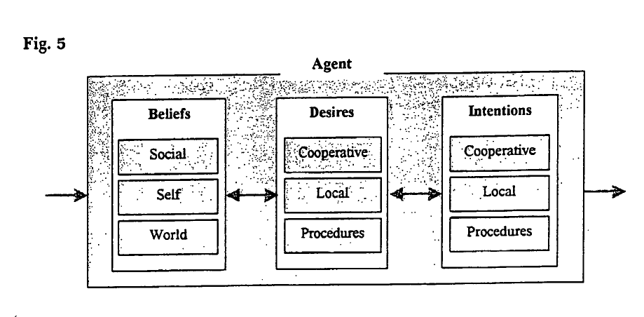

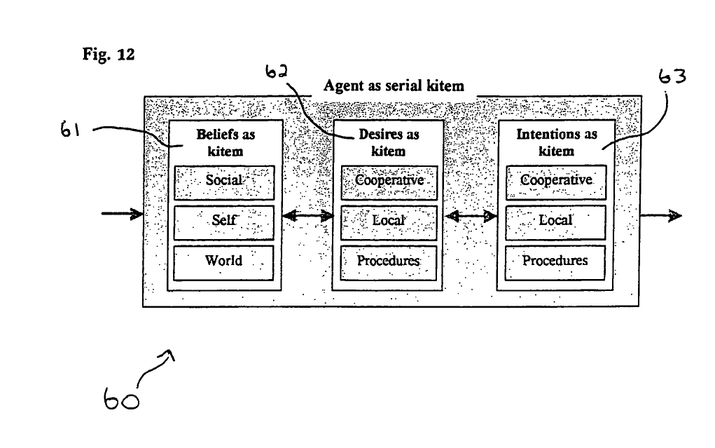

An agent, as illustrated in FIG. 5, can be represented as a kitem 60 with the structure illustrated in FIG. 12.:
Beliefs 61, Desires 62 and Intentions 63 are parallel kitems (their respective components are also kitems);
the Beliefs 61, Desires 62 and Intentions 63 kitems are organised in a serial architecture. That is, the agent kitem is a serial kitem;
the destination and output region of the Beliefs kitem map on the source and source region of the Desires kitem;
the destination and output region of the Desires kitem map on the source and source region of the Intentions kitem.

It is recommended but not essential that the kitems that comprise the agent operate in a synchronous mode. Internal synchronous processing is possible, even if a multi-agent systems behaves asynchronously. As an agent is a kitem, a multi-agent system is a multi-kitem system with a parallel architecture and continuous asynchronous processing.

Kitems Needed for A Workable Solutions

The kitems needed to produce a workable implementation for knowledge management are shown below:

Context Management

Context Elements

A context element is a display kitem (a serial kitem made of two kuarks).

Source and Destination Contexts

A source or destination context kitem is a parallel display kitem. Its members comprise the list of all the context elements defined in the domain of discourse.

Context Executable Kitems
Edit a context element
Edit a context space
Display a context space as a tree

A source or destination context tree is an executable kitem. The display kitem can display the elements that belong to the source and destination kitems. Its source context is the source or destination kitem and its destination context is the visual tree-like representation of the context.

Knowledge Definition

Knowledge Editing Kitem

The knowledge editing kitem is an executable kitem that has:
As source space: the source and destination contexts.
As destination space: the source and destination contexts.
As source region: a subset of the source context that defines the applicability of the knowledge kitem.
As mapping:
a link to a subset of the destination context, or
a procedure or executable (sub-)kitem.
As destination region:
a subset of the destination context that defines the outcome of the mapping, or
the outcome of the procedure.
An explanation.

Knowledge Access and Display

Search Kitem

The search kitem is an executable kitem with:
as source context: the source and destination contexts;
as source region: the enquiry as defined so far;
as destination context: the kitems in the domain of discourse (if known);
as mapping: the search process that identifies the candidate and definite kitems with respect to the enquiry;
as destination region: the candidate and definite kitems ‘retrieved’ by the mapping.

Enquiry or Consolation Kitem

The enquiry kitem is an executable kitem with:
as source space: the enquiry (the consultation process, showing each step in the question-answer session);
as destination space: the status of the enquiry (answered, not answered, etc.), the ids of the definite kitems.

Display Kitem

The display kitem is an executable kitem with:
as source space: the kitems to be displayed (itself another kitem); the display parameters;
as destination space: the code that puts the kitems on the screen in a hierarchical way.

Administration of Contexts and Other Kitems

The hierarchical (tree) structure of the kitems gives a very convenient way of controlling user access to kitems:
the administrator can decide which branch of the hierarchy users can have access to and the type of access for the branch and each kitem in the branch;
access control can also be carried out at the level of the kitem.

Dynamic Kitem Management

The objective of dynamic kitem management is to be able to manage the integrity of the knowledge base when a kitem is edited. This issue is important as kitems (eg: a context kitem) can be used in many knowledge elements and a change in such a kitem can have impacts on the validity of these knowledge elements (from a knowledge viewpoint, not operational viewpoint). It is essential that the users are not left in the dark about the potential ramification of their changes and that they are helped in checking the validity of some affected kitems. As much as possible, the system should ensure the integrity of the knowledge itself.

The process for achieving the above is to:
use the enquiry process (by the system or the user) to retrieve all kitems that could be affected (the system or the user can specify the profile of the kitems affected by the change);
make the changes automatically if acceptable; or
ask the user to review/recertify the kitems affected (the system needs to provide guidance in this process).

The profile mentioned above refers to the values given to kitems in the source and destination context. The system treats these values as an enquiry and retrieves all the kitems that are compatible with the enquiry. Change to properties

All the properties of the kitems can be changed. Potentially, all the kitems that are linked to the kitem being edited are affected. Some properties and the way their editing can be handled is listed below.

Change to Source Context and Region
If a new context object is added: the system asks the user to specify the profile of the kitems that may be affected, the system retrieves these kitems and the user is asked to recertify them.
If an existing context object is edited or deleted: the system retrieves all the kitems that are related to this kitem (that contain it as part of a link for example) and asks the user to recertify them and to edit them if necessary before doing so.

Change to Destination Context and Region
As for a change to the source context and region.

Change to Mapping
The system retrieves all the kitems that are related to this kitem (that contain it as part of a link or region for example) and asks the user to recertify them and to edit them if necessary.

Change to Status (Enabled/Disabled/Archived)
The system retrieves all the kitems that are related to this kitem (that contain it as part of a link or region for example) and asks the user to recertify them and to edit them if necessary.

Change to the ‘Links to Other Kitems’
No checks required, the change is localised.

Consistency Issues

Consistency issues may arise in a knowledge base when some kitems have the following features:
kitems have overlapping (at least one common kitem with at least a common value) or identical destination regions with non-identical source regions;
kitems have disjointed destination regions with overlapping or identical source regions.

The system can easily have an agent that checks all the kitems in a knowledge base and identifies these kitems that may be inconsistent. The system presents the kitems to their authors for editing if necessary and recertification.

Missing Knowledge

Missing knowledge refers to parts of a domain of discourse for which there is no knowledge or inadequate knowledge. When the domain of discourse for a set of kitems is explicit, it is a simple matter to check that the union of the source regions in the kitems cover the entire source context. If it is not the case, it means that the some additional knowledge is required. The user can be informed and the location of this missing knowledge presented.

The location of the missing knowledge can be pointed out on each dimension (or context kitem) of the source context. The user selects a context item and a value (or range of values) for which there is no region, and the system responds by showing the other context items and their values for which there is no region. The user then selects a second context item and gives it some values (where there is no region), and so on for the other kitems if desired, until the user is confident of being able to add some missing knowledge.

New Kitems

When a new knowledge element is being saved (the user has finished its definition), the system checks that it is consistent with the other knowledge elements in the knowledge base (see section 12.2).

The system also retrieves all kitems that overlap with the new kitem's source and/or destination regions. The system informs the user that these kitems may be affected (their knowledge may be superseeded by the new kitem) and presents them to the user for checking.

The system can also ask the user to define the profile of the kitems that may be superseeded by the new kitem.

Terminology

| Term | Explanation |
|---|---|
| Applicability region | The region in the source context that determines |
| | whether the kitem is applicable. |
| Application context | The context for the application made of the source |
| or space | and destination contexts. |
| Available kitem | The status of a kitem that is available for an |
| | enquiry (the other status are definite, candidate |
| | and rejected. |
| Candidate kitem | A kitem that is compatible with the enquiry so far |
| | but for which the applicability conditions are not |
| | completely met. |
| Definite kitem | A kitem that is compatible with the enquiry so far |
| | with its applicability conditions completely met. |
| Destination context | The space of solutions considered by an |
| | application or a kitem. |
| Domain of discourse | The space of problems and solutions (or situations |
| | and outcomes) considered by an application or a |
| | kitem; it is made of the source and destination |
| | contexts. |
| Enquriy process | The agent or process that controls the question- |
| | answer session or consultation. |
| Executable mapping | A mapping that takes an input from the source |
| | context and applies an algorithm to it to produce |
| | an outcome. |
| Kitem | A object or element that comprises a source |
| | context and region, a destination context and |
| | region, and a mapping. |
| Knowledge item | A kitem that is used to express knowledge. |
| Kuark | An elementary kitem (the smallest building block) |
| | that can be used to build other kitems and/or |
| | complete applications. |
| Mapping | The transformation that is applied to a source |
| | region to produce a destination region or outcome. |
| Outcome | Another term for destionation region or solution. |
| Parallel kitem | A kitem comprising other kitems organised in |
| | parallel. |
| Rejected kitem | An kitem that is not compatible with an enquiry. |
| Relevance context | The destination context that expresses the range of |
| | possible relevance for kitems in an application. |
| Relevance region | A region in the relevance context. |
| Relevance status | The relevance of a kitem with respect to an |
| | enquiry (see GKMS patent for details). |
| Serial kitem | A kitem comprising other kitems organised in |
| | series. |
| Solution | Another term for destination region or outcome. |
| Source context | The space of outcomes considered by an |
| | application or a kitem. |

1. A generic knowledge software agent, or kuark, existing within a knowledge environment, and comprising:
a defined domain of discourse within the environment which determines a source context of information detectable by the kuark and a destination context of information identifiable by the kuark;
the kuark having a defined source region, or pattern, within the source context and a mapping between that source region and a defined destination region, or pattern, within the destination context; and
the kuark detects all environmental parameters compatible with the source region and source context so that when the source region is satisfied the mapping fires to determine the destination region in the destination context and makes it available to the environment where it can be observed by a user.

2. A software agent according to claim 1, and further comprising:
a univeral id;
a title;
an explanation, which may be multimedia;
a time and date created;
an author;
a time and date when last modified;
a person who last modified agent;
a version number;
a status to an enquiry, such as available, candidate, rejected, definite;
a description of the source context at time of last firing;
a description of destination context after last firing; or,
links to other kuarks.

3. A software agent according to claim 2, where the links are:
the hierarchical parent's universal id, and more than one parents could be allowed;
the id of the previous version kuark;
the ids of the kuarks that are part of this kuark; or,
the ids of the kuarks this kuark belongs to or is associated with.

4. A software agent according to claim 1, operating to:
create a daughter/parent kuark;
adopt an existing kuark as daughter or parent;
display an internal state (contexts, regions, mapping); or
make a copy each time it fires.

5. A software agent according to claim 1 where, depending on the the state of the environment with respect to the source context and source region, the kuark fires a relevance mapping that determines the relevance of the environment.

6. A software agent according to claim 1 where, the mapping is a program or procedure that takes as input some elements of the source context and produces, as output, a pattern that fits within the destination context, and. the mapping executes when the environment is compatible with the source context and the region.

7. A software agent according to claim 1, implemented as classes and objects using an object oriented language.

8. A system, or kitem, comprising more than one software agent according to claim 1, where the kitem has its own properties and methods in addition to those of its components

9. A process for constructing a system, or kitem, according to claim 8 from its components, comprising the steps of:
concatenating their source contexts;
concatenating their destination contexts;
concatenating their source regions;
concatenating their destination regions;
concatenating their mappings;
concatenating their explanations.

10. A process according to claim 9, comprising the additional step of building a list of the component kuarks or kitems.

11. A system, or kitem, according to claim 8, where all its components (kuarks or kitems) keep their individual contexts.

12. A system, or kitem, according to claim 8, where all its components have their individual contexts concatenated.

13. A system, or kitem, according to claim 8, expressed as an object containing another object.

14. A multi-kitem system comprising two or more systems, or kitems, according to claim 8, where the kitems are linked to one another.

15. A multi-kitem system according to claim 14, comprising a serial arrangement of kitems in which the destination context of one kitem is used as at least part of the source context of another.

16. A multi-kitem system according to claim 14, comprising a parallel arrangement of kitems in which the kitems that have independent (or disjointed), but can also have overlapping, source contexts.

17. A kitem according to claim 8, including within itself a multi-kitem system and having access to all the properties and methods of kitems contained within it, in addition to the properties that belong only to that kitem.

18. A kitem according to claim 15, comprising two kuarks, where the first kuark, depending on the the state of the environment with respect to the source context and source region, fires a relevance mapping that determines the relevance of the environment, and the second kuark uses the output of the first kuark as its source context and region, and a has a mapping which is a program or procedure that produces material to be displayed as output when the relevance mapping fires.

19. A kitem according to claim 15, comprising two kuarks, where the first kuark, depending on the the state of the environment with respect to the source context and source region, fires a relevance mapping that determines the relevance of the environment, and the second kuark uses the output of the first kuark as part of its source context and its source region, and a has a mapping which is a program or procedure that produces a destination region as output when the relevance mapping fires.

20. A searching process for identifying those kitems in a multi-kitem system according to claim 14, that have source regions compatible with an enquiry, the process comprising the step of: determining the ‘relevance status’ of a kitem with respect to the enquiry or consultation so far, where an available status is the default status of a kitem before a search takes place, a candidate kitem is one that is not incompatible with the enquiry so far, and a rejected kitem is one that is incompatible with the enquiry so far and a definite kitem is one for which the enquiry satisfies the source region.

21. A searching process according to claim 20, where the source context is organised as a tree structure, and each kitem is indexed against the context tree so that each object in the context possesses a list of the kitems it is associated with, and during the search questions are context objects and all the indexed kitems to the questions asked and answered so far in the consultation have their relevance status checked and modified if appropriate.

22. A searching process according to claim 21, where the tree structure is a modified context space kitem, and the enquiry process instantiates a consultation kitem at each iteration, which contains the list of the linked kitems affected by the enquiry, with their states.

23. A searching process according to claim 20, where the source context is organised as a tree structure in which each element is a kitem and the search process is also a kitem which flags the kitems in the tree structurre that correspond to the questions answered so far.

24. A searching process according to claim 23, where context tree element determines whether all the indexed elements have taken into account the values of the context tree element, and if so, it passes the value(s) to the indexed kitems and waits until all the responses have been received before the next step in the enquiry can proceed.

25. A searching process according to claim 24, where the tree structure is a modified context space kitem, and the enquiry process instantiates a consultation kitem at each iteration, which contains the list of the linked kitems affected by the enquiry, with their states.

26. A searching process according to claim 20, where the source region determines the state of the kitem's relevance status and, depending on its state, the mapping becomes applicable.

27. A searching process according to claim 20, where each kitem has a unique ID or address that determines its location in a distributed memory space or network, it also possess a set of applicability addresses that correspond to the kitems in its source region, and during processing, the enquiry process submits each answer to all the kitems which have, in their list of applicability addresses, the ID of the kitem that formed the question.

28. A searching process according to claim 27, where each kitem determines by itself whether it can fire or not:
the enquiry process submits its answers to the network;
the answers reach the kitems that have the corresponding addresses in their applicability list (the kitems that form the source region);
the kitems update their relevance status with respect to this enquiry;
if the relevance status is definite or candidate, the kitem sends its ID and its status to the enquiry process; and
the enquiry process, when submitting, sends its (return) address, an enquiry number and an enquiry step number. These numbers are returned by the kitems that reply and this enables the enquiry process to know what replies correspond to what enquiry, or enquiry step.

29. An agent comprising a kitem according to claim 15, and having the following structure:
Beliefs, Desires and Intentions are parallel kitems and their respective components are also kitems; and the Beliefs, Desires and Intentions kitems are organised in a serial architecture, that is the destination and output region of the Beliefs kitem map on the source and source region of the Desires kitem; the destination and output region of the Desires kitem map on the source and source region of the Intentions kitem.

30. A knowledge management system, comprising: a context element is a display kitem according to claim 18; a source or destination context kitem is a parallel display kitem, and its members comprise the list of all the context elements defined in the domain of discourse;
a context executable kitem to edit a context element, edit a context space or display a context space as a tree;
a source or destination context tree as an executable kitem, where the display kitem display the elements that belong to the source and destination kitems, its source context is the source or destination kitem and its destination context is the visual tree-like representation of the context;
a knowledge editing kitem is an executable kitem that has:
as source space: the source and destination contexts,
as destination space: the source and destination contexts,
as source region a subset of the source context that defines the applicability of the knowledge kitem,
as mapping a link to a subset of the destination context, or a procedure or executable (sub-)kitem,
as destination region a subset of the destination context that defines the outcome of the mapping, or the outcome of the procedure, and
an explanation;
a search kitem is an executable kitem with:
as source context the source and destination contexts,
as source region the enquiry as defined so far,
as destination context the kitems in the domain of discourse (if known),
as mapping: the search process that identifies the candidate and definite kitems with respect to the enquiry,
as destination region the candidate and definite kitems ‘retrieved’ by the mapping;
an enquiry kitem is an executable kitem with:
as source space the enquiry (the consultation process, showing each step in the question-answer session),
as destination space the status of the enquiry (answered, not answered, etc.), the ids of the definite kitems;
a display kitem is an executable kitem with: as source space: the kitems to be displayed (itself another kitem); the display parameters;
as destination space: the code that puts the kitems on the screen in a hierarchical way.
